(19) United States
(12) Patent Application Publication
(10) Pub. No.: US 2005/0278145 A1
(43) Pub. Date: Dec. 15, 2005

(54) Performance analysis program and method for generating the same

(75) Inventor: Hideki Yamamoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/150,259

(22) Filed: Jun. 13, 2005

(30) Foreign Application Priority Data
Jun. 11, 2004 (JP) 174555/2004

(51) Int. Cl. G06F 11/30

(52) U.S. Cl. 702/182

(57) ABSTRACT

A computer program product for a performance analysis program embodied on a computer-readable medium and comprising code that, when executed, causes a computer to perform the following steps. The first step is (a) executing a measurement start routine which starts a performance analysis. The second step is (b) executing a measurement end routine which ends said performance analysis. The three step is (c) executing a first time measurement command placed on at least one of before and after a first call statement which calls said measurement start routine. The fourth step is (d) executing a second time measurement command placed on at least one of before and after a second call statement which calls said measurement end routine.

The present application claims the benefit of patent application No. 2004-174555, filed in Japan on Jun. 11, 2004, the subject matter of which is hereby incorporated herein by reference.

### BACKGROUND OF THE INVENTION

1. Field of the Invention

The present invention relates to a performance analysis program and a method for generating the same. More particularly, the present invention relates to a performance analysis program which can carries out a performance analysis precisely and a method for generating the same.

2. Description of the Related Art

A computer has been remarkably improved on its performance in recent years. However, there is the limit on the performance improvement by increasing a clock frequency, which corresponds to an operation frequency for synchronizing respective circuits in the computer. Thus, a computer has been improved on its performance mostly by using the parallel processing.

The object of using the parallel processing is to make the performance higher than before. Whether or not this object is attained can be verified by actually analyzing the performance. So, the research of the parallel processing always requires the a performance analysis.

Here, the performance analysis implies the analysis of: a problem how long it takes to execute a particular portion of a program; a problem why the case happens; a problem how the relationship among the case and hardware parameters such as a processor number and a communication time; and other problems.

The most basic performance index to carry out the performance analysis is a turnaround time. However, in the case of the parallel processing, there is a plurality of processes executing at the same time. All of the processes do not always start at the same time and do not always end at the same time. Ideally, the period between the start time on which the first process starts and the end time on which the final process ends is defined as the turnaround time.

The program for carrying out the performance analysis to determine this turnaround time is the performance analysis program.

As the conventional performance analysis program, Japanese Laid Open Patent Application JP, Showa 63-148342, A discloses the loop execution period measuring method. When a performance analysis option is specified at a time of compiling, a call for a measurement start routine to start the performance analysis is embedded into a head of a subroutine or function call. At the same time, a call for a measurement end routine to end the performance analysis is embedded into an end of the subroutine or function call. After that, the performance analysis of each of the subroutine and function is carried out by executing an executable format program in which those measurement routines are embedded.

However, the above method executes a time measurement command after a measurement routine receives a control. Also, this executes a time measurement command before the original routine receives a control from the measurement routine. Usually, a prologue process based on a linkage rule such as a reservation of a stack region and a save of a register data is executed at the start of the subroutine or function. An epilogue process based on the linkage rule such as the release of the stack or the recovery of the register is carried out at the end of the subroutine or function.

Incidentally, the routine implies the set of program codes having a function for executing a particular process. Also, although it is not independent as the individual program codes, when several lines to several tens of lines of codes are set to carry out the particular process, that portion can be referred to as the routine.

The routine is roughly classified into two elements, depending on the roles in the program. The routine, which is firstly called in starting the program, for managing the progress of the entire program, is referred to as “a main routine”. The routine, which is called from the other routine during the execution of the program and operated, is referred to as “a subroutine”.

The similar prologue process and epilogue process exist even in the measurement start routine and measurement end routine for the performance analysis. Thus, the time measurement command is executed immediately after the prologue process and immediately before the epilogue process. However, the time obtained by this time measurement command includes the execution times of the prologue process and epilogue process.

The above method solves the problems by preliminarily estimating the time required to execute the prologue process and epilogue process and then subtracting the estimated time (a fixed value) from the time obtained in the time measurement command, in order to solve these problems.

However, in the case of this method, the estimated time to subtract the times of the prologue and epilogue processes is a fixed value. Thus, the time of a cache miss which occurs when the process proceeds to the measurement routine or when the process returens to the original routine from the measurement routine, and the time varied in executing process such as the delay time of a memory access which occurs in the save or recovery of the register data and the like (hereafter, referred to as a variation time) cannot be calculated as the measurement time. Hence, if there are so many number of the calls for the measurement routine, the difference between the actual execution time and the measurement time becomes great, which has severe influence on the performance analysis.

In conjunction with the above description, Japanese Laid Open Patent Application JP, Heisei 3-102437, A discloses the program performance measurement method. In this conventional method, the compile process for a user program executes the time measurement command after the measurement routine prologue process and before the measurement routine epilogue process. Thus, the variation time generated in the prologue and epilogue processes cannot be exactly reflected in the measurement time.

In conjunction with the above description, Japanese Laid Open Patent Application JP, Heisei 7-129438, A discloses a data processing performance analysis method. There is a hierarchical relationship among a plurality of subsystems and systems. Each of the plurality of subsystems or the systems is called from a calling agency, starts a processing, ends the processing and returns to the calling agency, based on the hierarchical relationship. The each of subsystems has the routine consists of a program. The system consists of the routine or the subsystem. This method includes: calling the timing measurement section included in an operating system and making the timing measurement section measuring the processing execution time from processing start to processing end of the routine, the subsystem and the system, by executing the performance measurement macro prepared in the calling point of the call agency of the routine, the subsystem or the system, when each of the routine, the subsystem and the system performs processing based on the hierarchical relationship. This method includes a means for controlling whether or not the performance measurement macro is executed in each calling point of the routine, the subsystem and the system performing processing based on the hierarchical relationship, thereby measuring the data processing execution time of the routine, the subsystem and the system.

In conjunction with the above description, Japanese Laid Open Patent Application JP, 2003-316611, A discloses a program performance analysis method. This method is to execute a performance analysis for each of functions constituting a program by collecting performance data of the each of functions. This method includes: performing the program; outputting a start data when starting of the function and an end data when ending of the function, which constituting the program; outputting an address data corresponding to an original function which calls the executed function after outputting the start data and the end data; and storing a performance the performance data of the executed function into the storing place indicated by the address data.

In conjunction with the above description, Japanese Laid Open Patent Application JP, 2002-082926, A discloses a distributed application testing and operation managing system. Distributed application operating environment including one or more kinds of the component communication platforms or process communication platforms is used. The component communication platform performs the communication between components as software components. The process communication platform performs the communication between the processes including the components. The system includes an application lifecycle management unit, a performance data obtaining unit, a quality measurement unit and a quality data collection analysis unit. The application lifecycle management unit stores necessary data as a server entry for starting and ending a server which includes the components and the processes with the components; stores a necessary set of the server entries as an application entry for starting and ending a distribution application of a set of one or more servers which provides one service; controls starting and ending the distribution application by the application entry; and stores real time constitution data of the application. The performance data obtaining unit obtains process performance data including a start time and an end time of the process, a process name, a server name which executes the process and a class name of a component if the server is the component, when the a process request is sent from another component or the process and the result of the process is returned from the server. The quality measurement unit calculates the process execution time, the process execution frequency and the process request response time of each server based on the process performance data and the response performance data obtained by the performance data obtaining unit; and generates an event message if each of these vales goes over a predetermined threshold. The quality data collection analysis unit collects and provides the data of the process execution time, the process execution frequency and the process request response time of each of the servers constituting one selected distributed application, from the set of the quality measurement units having these data; specifies a portion of a bottleneck for satisfying the performance quality of the distributed application based on these data, the application constitution data, and the dependency relationship data among the servers; collects and provides data of the time, the process ID, the component name, and the component class name regarding the emergency which is an emergency stop or a transition to an emergency that occurs in each of the servers constituting one selected distributed application, from the application lifecycle management unit and the quality measurement unit; and specifies a portion of a bottleneck for satisfying the reliability quality of the distributed application.

### SUMMARY OF THE INVENTION

Therefore, an object of the present invention to provide a performance analysis program and a method for generating the same in which an error of a time measurement can be reduced in a performance analysis, to carry out the performance analysis precisely.

This and other objects, features and advantages of the present invention will be readily ascertained by referring to the following description and drawings.

In order to achieve an aspect of the present invention, the present invention provides a computer program product for a performance analysis program embodied on a computer-readable medium and comprising code that, when executed, causes a computer to perform the following: (a) executing a measurement start routine which starts a performance analysis; (b) executing a measurement end routine which ends said performance analysis; (c) executing a first time measurement command placed on at least one of before and after a first call statement which calls said measurement start routine; and (d) executing a second time measurement command placed on at least one of before and after a second call statement which calls said measurement end routine.

In the computer program product, said first time measurement command placed on after said first call statement may be a command for obtaining a start time on which a time measurement for a process executed immediately after an execution of said measurement start routine is started; and said second time measurement command placed on before said second call statement may be a command for obtaining an end time on which a time measurement for a process executed immediately before an execution of said measurement end routine is ended.

In the computer program product, said first time measurement command placed on before said first call statement may be a command for obtaining an end time on which a time measurement for a process executed immediately before an execution of said measurement start routine is ended; and said second time measurement command placed on after said second call statement may be a command for obtaining an start time on which a time measurement for a process executed immediately after an execution of said measurement end routine is started.

The computer program product may further include at least one of subroutines; wherein said steps (a) to (d) are executed for each of said at least one of subroutines.

The computer program product may further include at least one of functions; wherein said steps (a) to (d) are executed for each of said at least one of functions.

In the computer program product, said measurement start routine and said measurement end routine may do not include said first time measurement command nor said second time measurement command.

In order to achieve another aspect of the present invention, the present invention provides a method for generating a performance analysis program, comprising: (f) judging whether or not a statement, which is included in a source program in a compilation process, is one of a subroutine and a function as a procedure; (g) embedding a first call statement for calling a measurement start routine into a head of said procedure, and embedding a second call statement for calling a measurement end routine into an end of said procedure; (h) embedding a first time measurement command into at least one of before and after said first call statement; and (i) embedding a second time measurement command into at least one of before and after said second call statement.

In the method for generating a performance analysis program, said step (h) may be (h1) embedding said first time measurement command after said first call statement, and said step (i) may be (i1) embedding said second time measurement command before said second call statement.

In the method for generating a performance analysis program, said step (h) may be (h2) embedding said first time measurement command before said first call statement, and said step (i) may be (i1) embedding said second time measurement command after said second call statement.

The method for generating a performance analysis program may further include (j) executing said steps (f) to (i) for all statements included in said source program during said compilation process.

In order to achieve still another aspect of the present invention, the present invention provides a computer program product for a method for generating a performance analysis program embodied on a computer-readable medium and comprising code that, when executed, causes a computer to perform the following: (f) judging whether or not a statement, which is included in a source program in a compilation process, is one of a subroutine and a function as a procedure; (g) embedding a first call statement for calling a measurement start routine into a head of said procedure, and embedding a second call statement for calling a measurement end routine into an end of said procedure; (h) embedding a first time measurement command into at least one of before and after said first call statement; and (i) embedding a second time measurement command into at least one of before and after said second call statement.

In the computer program product, said step (h) may be (h1) embedding said first time measurement command after said first call statement, and said step (i) may be (i1) embedding said second time measurement command before said second call statement.

In the computer program product, said step (h) may be (h2) embedding said first time measurement command before said first call statement, and said step (i) may be (i1) embedding said second time measurement command after said second call statement.

The computer program product may further include (j) executing said steps (f) to (i) for all statements included in said source program during said compilation process.

### BRIEF DESCRIPTION OF THE DRAWINGS

FIG. 1 is a block diagram showing a configuration of an information processor in which a performance analysis program of the present invention is installed;

FIG. 2 is a flowchart showing an operation of an embodiment of a method for generating a performance analysis program according to the present invention;

FIG. 3 is a flowchart showing the operation of the step S203 of the procedure judgment process;

FIG. 4 is a flowchart showing the operation of the step S204 of the measurement routine embedding process;

FIG. 5 is a flowchart showing an operation of the step S205 of the time measurement command embedding process;

FIG. 6 is an example of the flowchart showing the conventional performance analysis program;

FIG. 7 is an example of the flowchart showing the performance analysis program of the present invention

FIG. 8 is an example of the conventional performance analysis program; and

FIG. 9 is an example of the performance analysis program of the present invention.

### DESCRIPTION OF THE PREFERRED EMBODIMENTS

Embodiments of a performance analysis program and a method for generating the same according to the present invention will be described below with reference to the attached drawings.

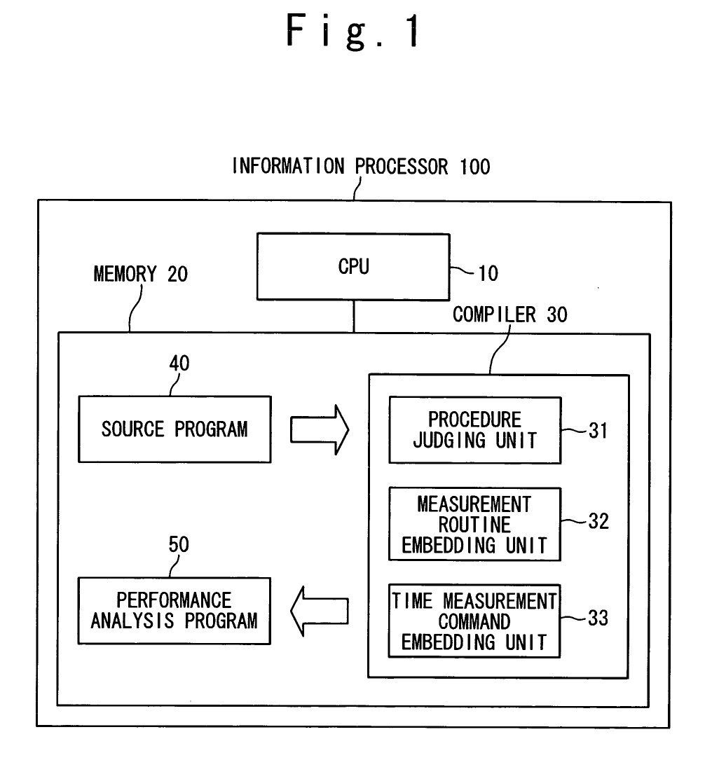

FIG. 1 is a block diagram showing a configuration of an information processor in which a performance analysis program of the present invention is installed.

The information processor 100 is exemplified by a general-purpose computer, a personal computer, a workstation and so on. The information processor 100 includes a CPU 10 and a memory 20.

The CPU 10 controls respective units of the information processor 100 and executes various programs.

The memory 20 stores a compiler 30. Also, the memory 20 stores a source program 40 and a performance analysis program 50 when a performance analysis is executed.

The compiler 30 is the software (program) basically for converting a source program (source code) into object code. The source program is described through a programming language by a human. The object code is a program which can be executed by the computer. In the present invention, the compiler 30 not only converts the source program 40 into object code, but also adds commands or routines to execute a performance analysis. Then, the compiler 30 outputs a performance analysis program 50. The commands or routines are added before or after the conversion. The performance analysis program 50 is the program of the object code, which can execute the performance analysis.

The compiler 30 executed by the CPU 10 generates the performance analysis program 50 from the source program 40.

The compiler 30 has a procedure judging unit 31, a measurement routine embedding unit 32 and a time measurement command embedding unit 33. These units are intended to embed the processes (commands or routines) necessary for the performance analysis, when the source program 40 is compiled.

Incidentally, the routine implies the set of the program codes having the function for executing a particular process. Also, although it is not independent as the individual program code, if several lines to several tens of lines of codes are set to carry out the particular process, that portion can be referred to as the routine.

The routine is roughly classified into two elements, depending on the roles in the program. The routine, which is firstly called in starting the program, for managing the progress of the entire program, is referred to as “a main routine”. The routine, which is called from the other routine during the execution of the program and operated, is referred to as “a subroutine”.

The procedure judging unit 31 judges whether or not a statement under the process is a CALL statement for calling the subroutine or function, in the process for compiling the source program 40 inputted to the compiler 30, and then returns its result.

Incidentally, the statement implies one completed command for carrying out a process inside the program. The program is constituted by the sets of such statements.

The measurement routine embedding unit 32 embeds the CALL statement for calling a measurement start routine, into a head of the subroutine or function under the process, in the process for compiling the source program 40. Further, the measurement routine embedding unit 32 embeds the CALL statement for calling a measurement end routine, into an end of the subroutine or function under the process.

The time measurement command embedding unit 33 embeds a time measurement command before and after the CALL statement for calling the measurement start routine embedded by the measurement routine embedding unit 32. Moreover, the time measurement command embedding unit 33 embeds the time measurement command before and after the CALL statement for calling the measurement end routine embedded by the measurement routine embedding unit 32.

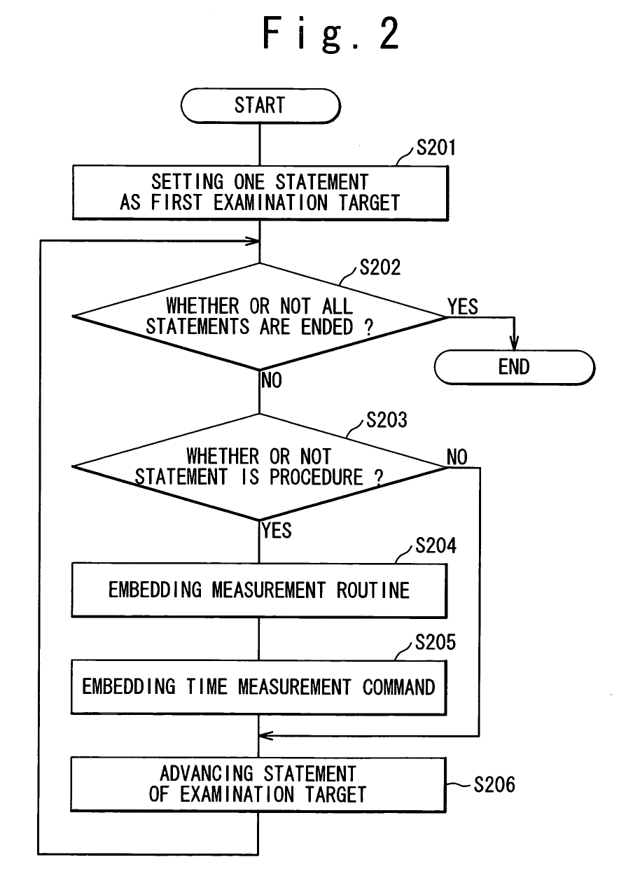

FIG. 2 is a flowchart showing an operation of an embodiment of a method for generating a performance analysis program according to the present invention.

This operation is the embedding process for the measurement routine in compiling the source program 40. At first, the compiler 30 sets one of the statements of the source program 40 that as the first examination target of the performance analysis, in the compiling process of the source program 40, and then starts the examination (Step S201).

Next, the compiler 30 judges whether or not the examination of all the statements is ended. Here, the all the statements are included in the source program 40 that is the examination target (Step S202).

Based on the judgment result, if the examination of all of the statements has been ended (Step S202: YES), the compiler 30 ends this process.

Based on the judgment result, if the examination of all the statements is not ended (Step S202: NO), next, the compiler 30 calls the procedure judging unit 31. The procedure judging unit 31 judges whether or not the statement under the examination is the procedure (the subroutine or function) (Step S203).

If the procedure judging unit 31 judges that the statement is the subroutine or function, the compiler 30 uses the measurement routine embedding unit 32 and executes embedding the measurement routine (Step S204).

After the execution of the measurement routine embedding at the step S204, the compiler 30 uses the time measurement command embedding unit 33 and executes the embedding the time measurement command (Step S205).

Finally, the compiler 30 executes a process for advancing the statement of the examination target by one (Step S206). After that, the compiler 30 returns to the process for judging whether or not all the statements have been examined (Step S202).

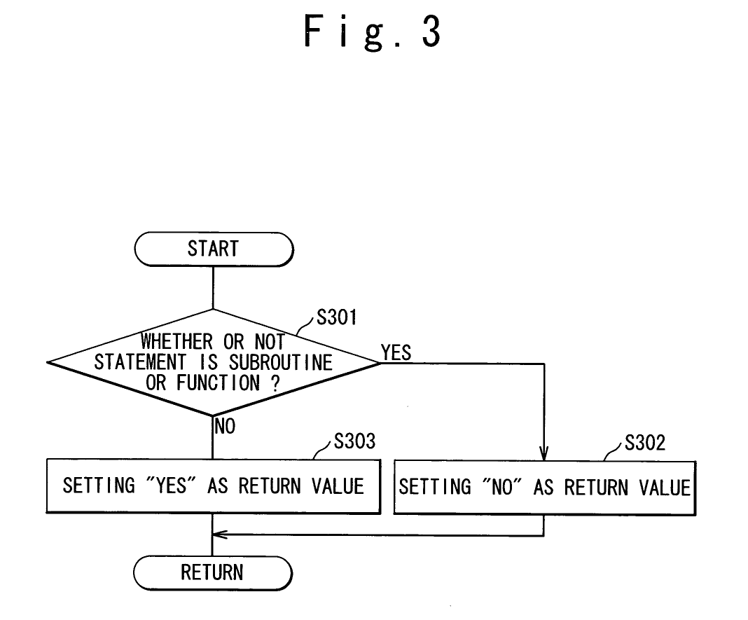

FIG. 3 is a flowchart showing the operation of the step S203 of the procedure judgment process.

In the procedure judgment process, the procedure judging unit 31 judges whether or not the statement under the process is the subroutine or function (Step S301).

Based on the judgement result, if the statement under the process is the subroutine or function, the procedure judging unit 31 returns a value indicating a key word “Yes” as a return value (Step S302).

Based on the judgement result, if the statement is not the subroutine nor function, the procedure judging unit 31 returns a value indicating a key word “No” as the return value (Step S303).

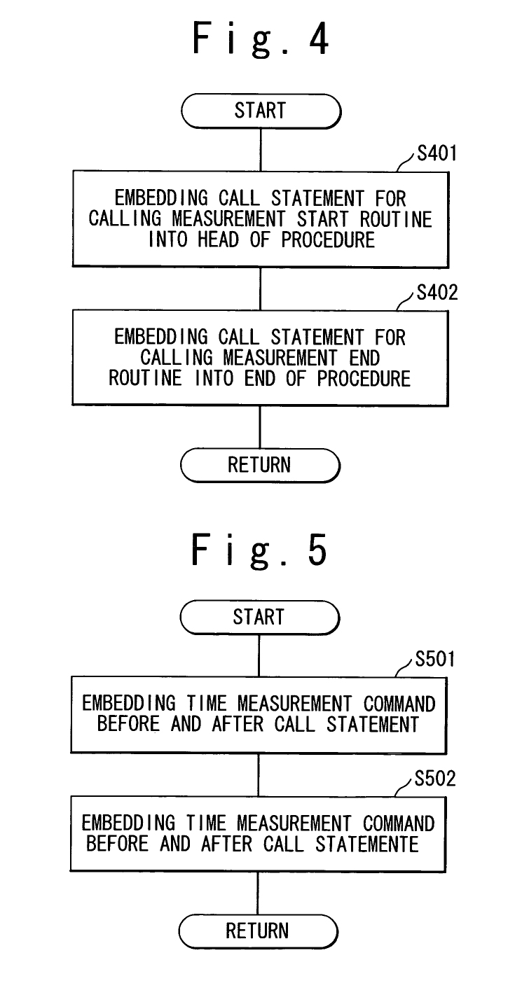

FIG. 4 is a flowchart showing the operation of the step S204 of the measurement routine embedding process.

At first, the measurement routine embedding unit 32 embeds the CALL statement for calling the measurement start routine, into the head of the procedure under the process (Step S401).

Then, the measurement routine embedding unit 32 embeds the CALL statement for calling the measurement end routine, into the end portion of the procedure under the process (Step S402).

FIG. 5 is a flowchart showing an operation of the step S205 of the time measurement command embedding process.

At first, the time measurement command embedding unit 33 embeds the time measurement command before and after the CALL statement for calling the measurement start routine (Step S501).

Then, the time measurement command embedding unit 33 embeds the time measurement command before and after the CALL statement for calling the measurement end routine (Step S502).

Next, the embodiment of the performance analysis program of the present invention will be described below by comparing the flowchart with that of the conventional performance analysis program.

Here, as an example, both of the conventional and the present invention's performance analysis program are executed on the information processor 100 having the CPU 10. In this case, CPU 10 executes the performance analysis program.

However, the this execution environment is only the example for the explanation. Actually, the execution environment of the performance analysis program in the present invention is not limited to on the above-mentioned information processor.

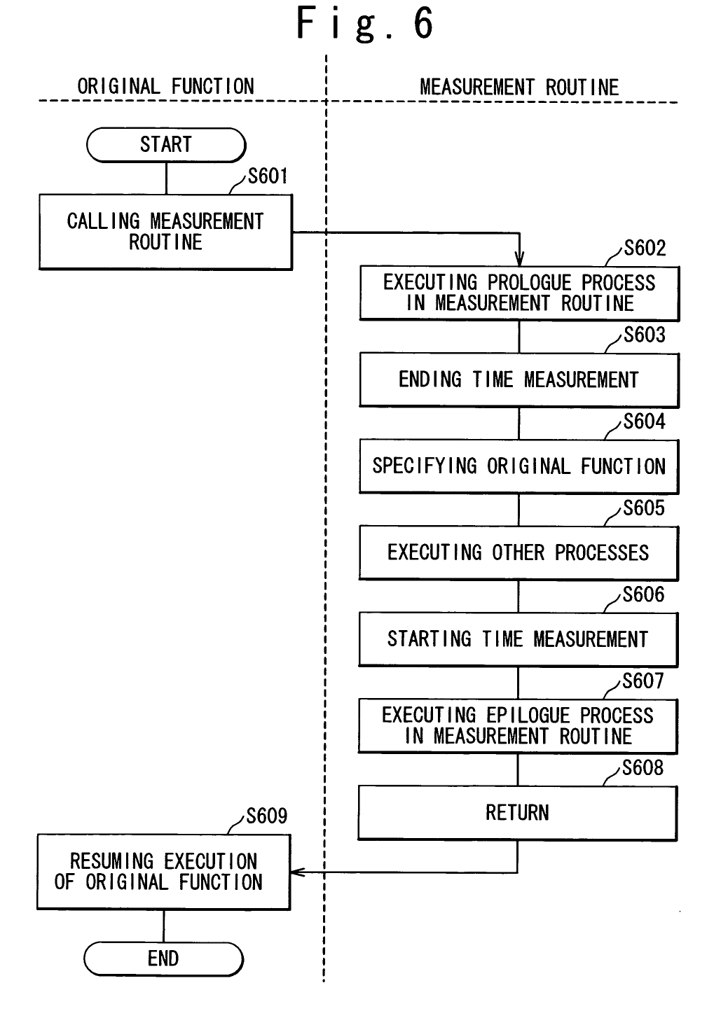

At first, the conventional performance analysis program will be described below. FIG. 6 is an example of the flowchart showing the conventional performance analysis program. In the conventional performance analysis program, if the call for the measurement routine is carried out during the execution of a original function, it proceeds to the process for the measurement routine (Step S601).

When the process for the measurement routine is started, the prologue process is executed based on the linkage rule (Step S602). Here, the prologue process is exemplified by the reservation of a stack region and the saving of data in registers.

The conventional performance analysis program is the method such that the time measurement is ended after the execution of the prologue process for the measurement routine. The time obtainment command is executed, and then, the time measurement is ended (Step S603).

Incidentally, if the measurement routine under the execution is the measurement start routine, this corresponds to the process for ending the time measurement with regard to the original functions executed between the portion immediately before the epilogue process of the last measurement end routine and the portion immediately after the prologue process of the measurement start routine.

If the measurement routine under the execution is the measurement end routine, this corresponds to the process for ending the time measurement with regard to the subroutines executed between the portion immediately before the epilogue process of the last measurement start routine and the portion immediately after the prologue process of the measurement end routine.

After the time measurement is ended, the process for specifying the original function, which calls the measurement routine under the execution, is executed (Step S604).

By specifying the function, it is possible to relate the function to the result of the performance analysis, to collect the performance data for each function and to manage the performance data through table storage.

After the original function is specified, the calculation of the performance analysis and the other processes are executed (Step S605).

In the conventional performance analysis program, after the execution of the above-mentioned and other processes, the time measurement is started. Here, this executes the time obtainment command and starts the time measurement (Step S606).

Incidentally, if the measurement routine under the execution is the measurement start routine, this corresponds to the process for starting the time measurement with regard to the subroutines to be executed between the portion immediately before the epilogue process for the measurement start routine and the portion immediately after the prologue process of the measurement end routine.

If the measurement routine under the execution is the measurement end routine, this corresponds to the process for starting the time measurement with regard to the original functions to be executed between the portion immediately before the epilogue process for the measurement end routine and the portion immediately after the prologue process of a next measurement start routine.

After the start of the time measurement, the epilogue process based on the linkage rule is executed (Step S607). Here, the epilogue process is exemplified by the open of the stack and the recovery of the register data.

When the measurement routine is ended, among the values obtained from the process for the measurement routine, the value required from the original function and the value necessary for the performance analysis process are returned as the return value (Step S608).

After the measurement routine is ended, the execution of the original function is resumed (Step S609).

Incidentally, if the process for again calling the measurement routine is executed during the execution of the original function, it proceeds to the process at the step S601.

In the conventional performance analysis program, the measurement time is measured through the above process. However, there is a problem that in the measurement routine, a cache miss and a branch prediction miss are generated which results in the fluctuation in the execution time for each execution. The cache miss implies the fact that a desirable data cannot be found out in spite of the access to a cache in which data is a transiently stored.

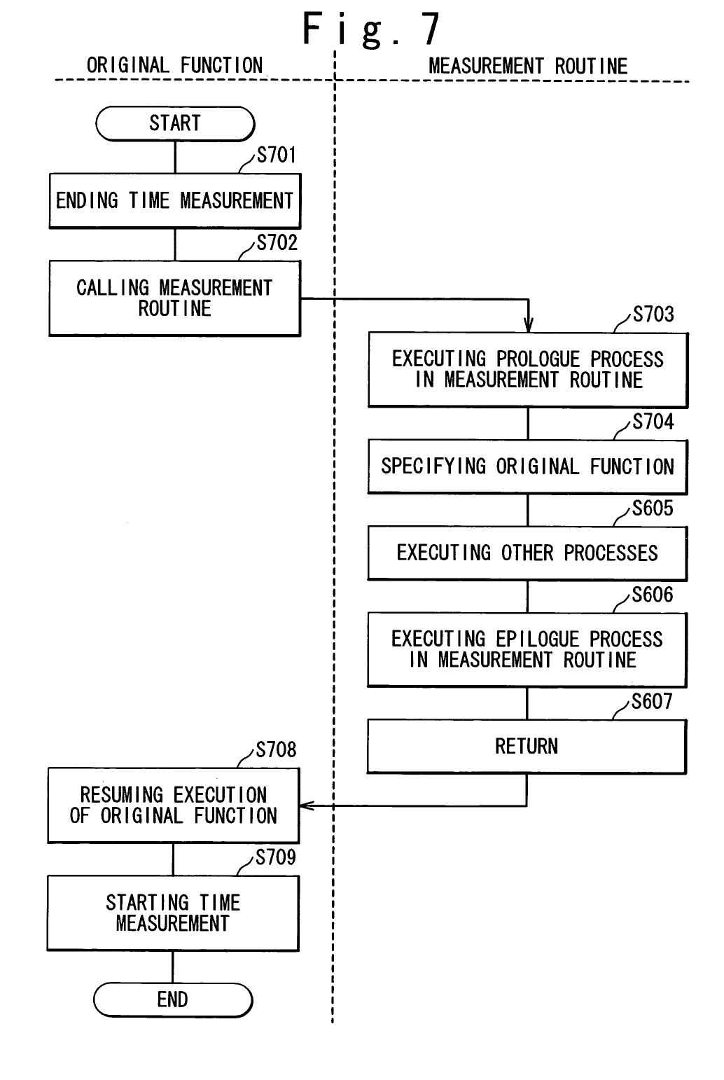

Next, the performance analysis program of the present invention will be described below. FIG. 7 is an example of the flowchart showing the performance analysis program of the present invention.

The performance analysis program of the present invention is the method such that the time measurement is ended immediately before the measurement routine is called. Then, the time obtainment command is executed, and the time measurement is ended (Step S701).

Incidentally, if the measurement routine under the execution is the measurement start routine, this corresponds to the process for ending the time measurement with regard to the original function executed between the portion immediately after the end of the last measurement end routine and the portion immediately before the start of the measurement start routine.

If the measurement routine under the execution is the measurement end routine, this corresponds to the process for ending the time measurement with regard to the subroutine executed between the portion immediately after the end of the last measurement start routine and the portion immediately before the start of the measurement end routine.

In the performance analysis program of the present invention, after the process for ending the time measurement, the call for the measurement routine is executed (Step S702). Thus, the measurement routine is called, and the process for the measurement routine is started.

When the process for the measurement routine is started, the prologue process is executed based on the linkage rule (Step S703). The prologue process is exemplified by the reservation of the stack region and the saving of data in the registers.

The process for specifying the original function, which calls the measurement routine under the execution, is executed (Step S704).

By specifying the function, it is possible to relate the function to the result of the performance analysis, to collect the performance data for each function and to manage the performance data through the table storage.

After the original function is specified, the calculation of the performance analysis and the other processes are executed (Step S705).

After the start of the time measurement, the epilogue process is executed based on the linkage rule (Step S706). The epilogue process is exemplified by the open of the stack and the recovery of the register data.

When the measurement routine is ended, among the values obtained from the process for the measurement routine, the value required from the original function and the value necessary for the performance analyzing process are returned as the return value (Step S707).

After the measurement routine is ended, the execution of the original function is resumed (Step S708).

In the performance analysis program of the present invention, after the resumption of the execution of the original function, the time measurement is started. Here, the time obtainment command is executed, and the time measurement is started (Step S709).

The present invention can reduce the error in the time which exists between the time measurement command and the call for the measurement routine in the conventional process, by carrying out the partial in-line process of the time measurement in immediately before or immediately after the CALL statement for calling the measurement routine.

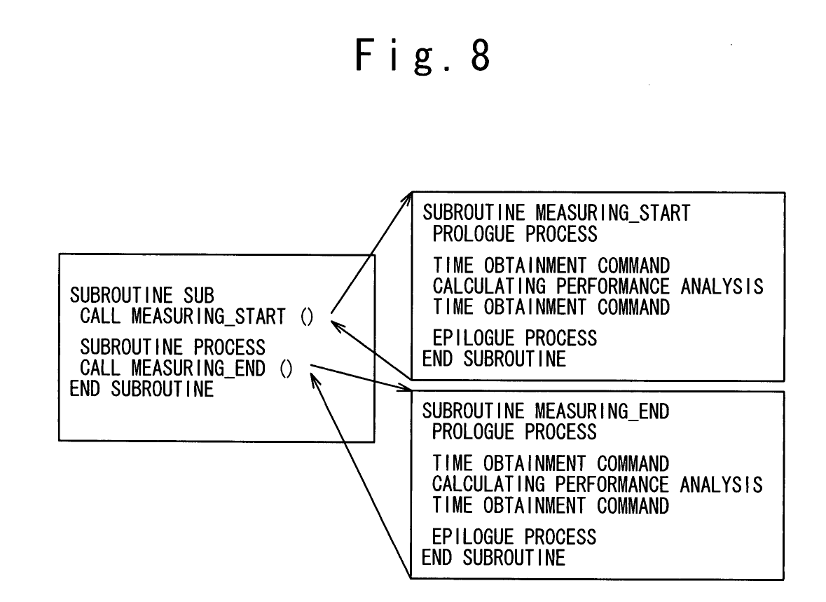

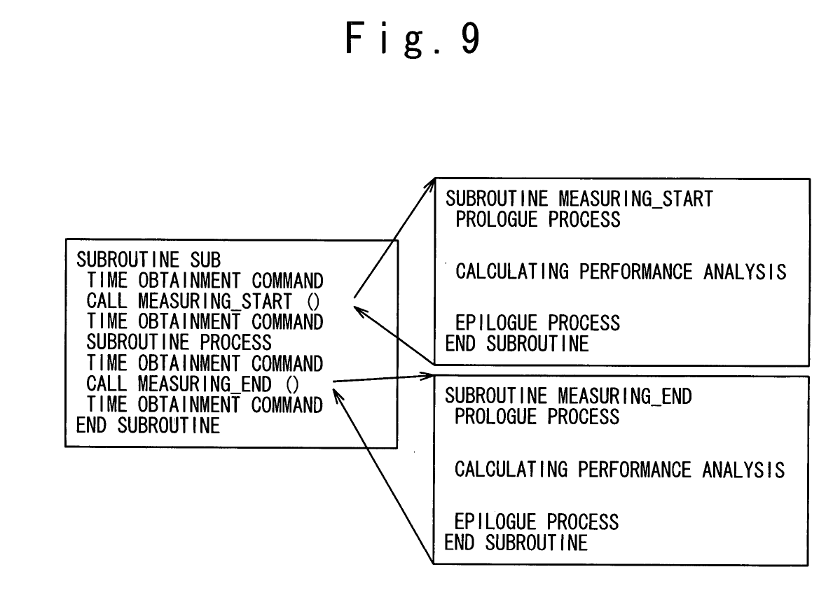

FIG. 8 is an example of the conventional performance analysis program. FIG. 9 is an example of the performance analysis program of the present invention.

In FIG. 8, “call measuring_start ( )” is the CALL statement for calling the measurement start routine, and “call measuring_end ( )” is the CALL statement for calling the measurement end routine. “Subroutine measuring_start” is the measurement start routine. “Subroutine measuring_end” is the measurement end routine. In the conventional performance analysis program, the time obtainment command is executed immediately after the prologue process within the routine and immediately before the epilogue process, in both of the measurement start routine and the measurement end routine.

Similarly to the case of FIG. 8, in FIG. 9, “call measuring_start ( )” is also the CALL statement for calling the measurement start routine, “call measuring_end ( ) ” is also the CALL statement for calling the measurement end routine, “Subroutine measuring_start” is the measurement start routine, and “Subroutine measuring_end” is the measurement end routine.

In the performance analysis program of the present invention, the time obtainment command is executed before and after the call for the measurement start routine and before and after the call for the measurement end routine.

In the conventional method, as shown in FIG. 8, the time measurement command is executed after the prologue process of the measurement routine and before the epilogue process. Thus, the variation time generated at the prologue process and epilogue process cannot be accurately reflected in the measurement time.

On the other hand, in the method of the present invention, as shown in FIG. 9, the time measurement command is inserted before and after the CALL statement of the measurement start routine for the performance analysis, and the time measurement command is further inserted before and after the CALL statement of the measurement end routine. Then, by measuring the time except the time required for the prologue process and epilogue process, it is possible to attain the more precise performance analysis.

The present invention, since executing the time measurement command before the call for the measurement routine, solves the problem where if the number of the calls for the measurement routine is great, the difference between the actual execution time and the measurement time becomes great, which has the severe influence on the performance analysis.

Also, using the present invention solves the variation time in the execution of the prologue process and the epilogue process, which cannot be conventionally analyzed, and improves so as to carry out the performance analysis more precisely.

In the conventional time measuring method, the variation time included in the measurement of the execution time with regard to the subroutine or function in which the number of the call times is great becomes great, and there is the problem of a precision. However, with the application of this method, the variation time is not measured, which enables the time to be measured more precisely.

That is, the time measurement command is inserted before and after a measurement start routine CALL statement for the performance analysis, and the time measurement command is further inserted before and after a measurement end routine CALL statement. Thus, the more precise performance analysis becomes possible by measuring the time except the time necessary for the prologue process and epilogue process.

Also, according to the present invention, it can be applied to the use field for examining which of the subroutines or functions is a bottleneck in carrying out a performance tuning of a computer program.

It is apparent that the present invention is not limited to the above embodiment, that may be modified and changed without departing form the scope and spirit of the invention.

1. A computer program product for a performance analysis program embodied on a computer-readable medium and comprising code that, when executed, causes a computer to perform the following:
(a) executing a measurement start routine which starts a performance analysis;
(b) executing a measurement end routine which ends said performance analysis;
(c) executing a first time measurement command placed on at least one of before and after a first call statement which calls said measurement start routine; and
(d) executing a second time measurement command placed on at least one of before and after a second call statement which calls said measurement end routine.

2. The computer program product according to claim 1, wherein said first time measurement command placed on after said first call statement is a command for obtaining a start time on which a time measurement for a process executed immediately after an execution of said measurement start routine is started; and
said second time measurement command placed on before said second call statement is a command for obtaining an end time on which a time measurement for a process executed immediately before an execution of said measurement end routine is ended.

3. The computer program product according to claim 1, wherein said first time measurement command placed on before said first call statement is a command for obtaining an end time on which a time measurement for a process executed immediately before an execution of said measurement start routine is ended; and
said second time measurement command placed on after said second call statement is a command for obtaining an start time on which a time measurement for a process executed immediately after an execution of said measurement end routine is started.

4. The computer program product according to claim 1, further comprising:
at least one of subroutines;
wherein said steps (a) to (d) are executed for each of said at least one of subroutines.

5. The computer program product according to claim 1, further comprising:
at least one of functions;
wherein said steps (a) to (d) are executed for each of said at least one of functiones.

6. The computer program product according to claim 1, wherein said measurement start routine and said measurement end routine do not includes said first time measurement command nor said second time measurement command.

7. A method for generating a performance analysis program, comprising:
(f) judging whether or not a statement, which is included in a source program in a compilation process, is one of a subroutine and a function as a procedure;
(g) embedding a first call statement for calling a measurement start routine into a head of said procedure, and embedding a second call statement for calling a measurement end routine into an end of said procedure;
(h) embedding a first time measurement command into at least one of before and after said first call statement; and
(i) embedding a second time measurement command into at least one of before and after said second call statement.

8. The method for generating a performance analysis program according to claim 7, wherein said step (h) is:
(h1) embedding said first time measurement command after said first call statement, and
said step (i) is:
(i1) embedding said second time measurement command before said second call statement.

9. The method for generating a performance analysis program according to claim 7, wherein said step (h) is:
(h2) embedding said first time measurement command before said first call statement, and
said step (i) is:
(i1) embedding said second time measurement command after said second call statement.

10. The method for generating a performance analysis program according to claim 7, further comprising:
(j) executing said steps (f) to (i) for all statements included in said source program during said compilation process.

11. A computer program product for a method for generating a performance analysis program embodied on a computer-readable medium and comprising code that, when executed, causes a computer to perform the following:
(f) judging whether or not a statement, which is included in a source program in a compilation process, is one of a subroutine and a function as a procedure;
(g) embedding a first call statement for calling a measurement start routine into a head of said procedure, and embedding a second call statement for calling a measurement end routine into an end of said procedure;
(h) embedding a first time measurement command into at least one of before and after said first call statement; and
(i) embedding a second time measurement command into at least one of before and after said second call statement.

12. The computer program product according to claim 11, wherein said step (h) is:
(h1) embedding said first time measurement command after said first call statement, and
said step (i) is:
(i1) embedding said second time measurement command before said second call statement.

13. The computer program product according to claim 11, wherein said step (h) is:
(h2) embedding said first time measurement command before said first call statement, and
said step (i) is:
(i1) embedding said second time measurement command after said second call statement.

14. The computer program product according to claim 11, further comprising:
(j) executing said steps (f) to (i) for all statements included in said source program during said compilation process.
